(19) United States
(12) Patent Application Publication
(10) Pub. No.: US 2013/0121565 A1
(43) Pub. Date: May 16, 2013

(54) Method and Apparatus for Local Region Selection

(71) Applicants: Jue Wang, (US); Aseem O. Agarwala, (US)

(72) Inventors: Jue Wang, (US); Aseem O. Agarwala, (US)

(21) Appl. No.: 12/474,030

(22) Filed: May 28, 2009

(51) Int. Cl. G06K 9/62

(52) U.S. Cl. 382/159

(57) ABSTRACT

Methods and apparatus for local region selection are described. A scribble-based, edge-aware local region selection tool or module that implements a local region selection method may allow a user to draw scribbles or strokes indicating different classes of content. The method may train Gaussian mixture models (GMMs) for each class from the user input. The GMMs may be applied to the image to generate a probability map for each class. Post-processing may be optionally performed to remove structural outliers. The probability maps may be smoothed using a geodesic smoothing technique. A geodesic smoothing technique may be applied that considers other classes when smoothing each class to limit or prevent propagation of a region corresponding to the class into other regions corresponding to other classes. The smoothed probability maps may be combined to generate a final region selection mask.

### BACKGROUND

### Description of the Related Art

Local manipulation of color and tone is a common operation in the digital imaging workflow. For example, to improve a photograph or video sequence, an artist may increase the saturation of grass regions, make the sky bluer, and brighten the people. Conventionally, localized image editing is performed by carefully isolating the desired regions using selection tools to create mattes. While effective, this conventional approach can be more time-consuming than is necessary or desired for color and tone adjustments, especially for video. Matting techniques are primarily designed for cutting an object from one image and pasting it into another, in which case it is important to solve the matting equations and recover foreground colors de-contaminated of the background. In contrast, in the case of color and tonal adjustment, everything is performed in place, within the original image. Thus, local edits may be interpolated directly and more easily without the need to solve the matting equations.

A technique referred to as edge-aware interpolation (EAI) takes this approach, and offers the user a different interface to localized manipulation that does not require any explicit selection or masking from the user. Instead, the user simply draws rough scribbles or strokes on the image (e.g., one on the grass, one on the sky, and one on the people), and attaches adjustment parameters to each scribble. These adjustments parameters are then interpolated to the rest of the image or video in a fashion that respects image edges, i.e., the interpolation is smooth where the image is smooth. At a high level, EAI works by propagating the influence of each scribble along paths of pixels of similar luminance; image edges slow this propagation. A problem with conventional EAI techniques is that texture edges within an object also slow propagation. Texture edges may not be a problem if they are weak relative to object boundary edges, but this is often not the case. Another problem with conventional EAI techniques is the manipulation of fragmented appearances (such as blue sky peeking through the leaves of a tree, or a multitude of flowers) since the influence of scribbles will be stopped by the edges in-between; the user must therefore scribble each fragment.

### SUMMARY

Various embodiments of methods and apparatus for local region selection are described. Embodiments may provide a scribble-based, edge-aware local region selection tool or module that enables a user to draw scribbles or strokes indicating different classes of content that the user wishes to manipulate differently. Given an input image, the user may specify or enter scribbles, for example via a user interface that provides a brush or other tool whereby the user may draw strokes or scribbles on the image. The scribbles indicate the classes of content that the user wants to select. Color models may be built and applied. In some embodiments, given the user-specified scribbles, the local region selection method trains Gaussian Mixture color models (GMMs) for each class; the GMMs capture the color statistics of pixels selected by the user (e.g., the pixels “under” the scribbles). The GMMs are then applied to the image to generate a probability map for each class. A probability map for a class indicates, for each pixel in the image, a probability that the pixel is in the respective class. In some embodiments, probabilities may be indicated within the range (0 . . . 1), inclusive. Post-processing may be optionally performed to remove structural outliers from the probability maps. The probability maps may then be smoothed using a geodesic smoothing technique. Geodesic smoothing may be applied, for example, to smooth transitions between regions (a region may be defined as an area in an image that includes pixels of a particular class corresponding to the region), and to classify areas of unclassified pixels. In some embodiments, a geodesic smoothing technique may be used that considers other classes when smoothing each region to limit or prevent propagation of regions into other regions. The smoothed probability maps are combined to generate a final region selection mask.

### BRIEF DESCRIPTION OF THE DRAWINGS

FIG. 1 shows the workflow of a local region selection method according to some embodiments.

FIG. 2 is a flowchart of a method for local region selection according to some embodiments.

FIGS. 3A and 3B show an example of an initial probability map computed according to some embodiments.

FIG. 3C shows an example of a final region selection mask produced by applying geodesic smoothing to the map of FIG. 3B, according to some embodiments.

FIGS. 4A and 4B show an example of computing geodesic distances and of geodesic smoothing according to some embodiments.

FIG. 5A shows an initial mask generated using color models according to some embodiments.

FIGS. 5B and 5C show the mask of FIG. 5A after geodesic smoothing according to some embodiments.

FIGS. 6A and 6B show the mask of FIG. 5A using an alternative geodesic smoothing technique that limits or prevents propagation of one region into another region, according to some embodiments.

FIG. 7 graphically illustrates a forward pass over a region using a forward kernel and a backward pass over the same region using a backward kernel, according to some embodiments.

FIG. 8 illustrates a local region selection module that may generate final region selection masks from input images and user input, according to some embodiments.

FIG. 9 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

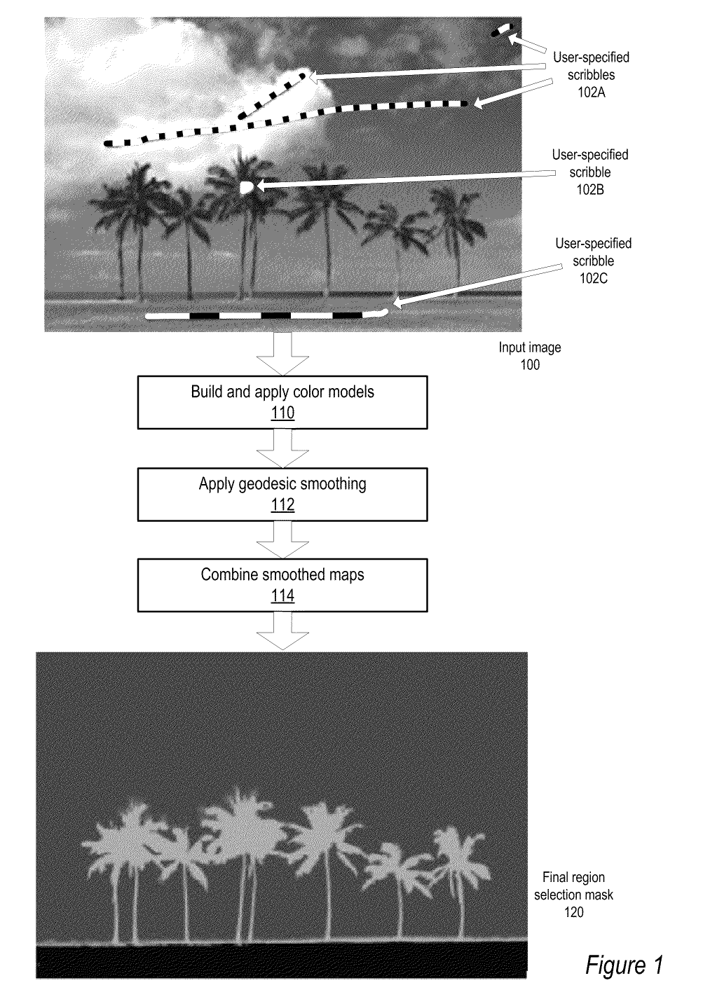

Various embodiments of methods and apparatus for local region selection are described. FIG. 1 shows the workflow of a local region selection method according to some embodiments. Embodiments may provide a scribble-based, edge-aware local region selection tool or module that enables a user to draw scribbles 102 or strokes indicating different classes of content that the user wishes to manipulate differently, as shown in input image 100 of FIG. 1. For example, as shown in FIG. 1, classes may include sky, grass and trees. Note that input image 100 is a grayscale representation of a color image, as are other example images shown in the Figures. Input image 100 may be a digitally-captured image such as a digital photograph, a digitized image such as a digitized conventional photograph, a digital video frame, or in general any digital image. While embodiments are generally directed at processing color images, embodiments may also be applied to grayscale images.

Given input image 100, the user may specify or enter scribbles 102, for example via a user interface that provides a brush or other tool whereby the user may draw strokes or scribbles on the image. The scribbles 102 indicate parts of the image that the user wants to select as classes of content. In FIG. 1, the different types of lines (i.e., the solid white line 102B and the different black-and-white dashed lines 102A and 102C) used in the scribbles 102 indicate that the user has marked different target classes of the image (in this example, three different classes). Note that, in color imaging, different colors may be used to indicate different classes. Two or more distinct scribbles 102 may be applied at different locations in the image 100 to specify different parts of the image that are of the same class. See, for example the three distinct scribbles 102A which all specify the same class.

The image 100 may then be partitioned into multiple regions or layers corresponding to the classes as specified by the scribbles 102. A region may be defined as an area in an image that includes pixels of a particular class corresponding to the region. Color models may be built and applied, as indicated at 110. In some embodiments, given the user-specified scribbles 102, the local region selection method trains Gaussian Mixture models (GMMs) for each class; the color models capture the color statistics of pixels selected by the user (e.g., the pixels “under” the scribbles). The GMMs are then applied to the image to generate a probability map for each class. A probability map for a class indicates, for each pixel in the image, a probability that the pixel is in the respective class. In some embodiments, probabilities may be indicated within the range (0 . . . 1), inclusive. Other embodiments may use other ranges. As indicated at 112, these probability maps are then smoothed using a geodesic smoothing technique, and the smoothed probability maps are combined to generate a final region selection mask at 114.

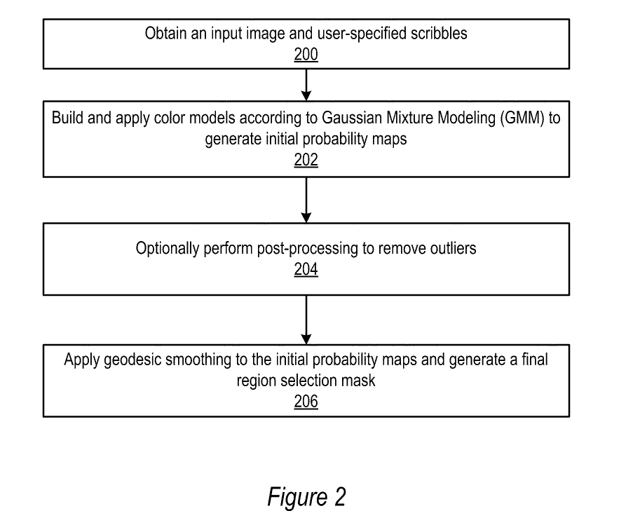

FIG. 2 is a flowchart of a method for local region selection according to some embodiments. As indicated at 200, an input image and user-specified scribbles indicating classes may be obtained. As indicated at 202, color models (GMMs) may be built according to Gaussian mixture modeling, and the GMMs may be applied to the image to generate initial probability maps for the classes. As indicated at 204, post-processing may be optionally performed to remove structural outliers from the probability maps. As indicated at 206, a geodesic smoothing technique may be applied to the probability maps, and the smoothed maps may be combined, to generate a final region selection mask. Details of these elements are provided below.

### GMM Color Models

As indicated at 202 of FIG. 2, embodiments may use a Gaussian mixture model (GMM) as a color model. In some embodiments, given a set of training pixels Iᵢ=(Lᵢ, aᵢ, bᵢ), i=1, . . . , n, and a maximum cluster number kₘₐₓ, a GMM method may perform the following steps to estimate its parameters. A clustering algorithm, for example a K-Mean clustering algorithm, may be applied to cluster pixels into kₘₐₓ distinct clusters. The final cluster number may be smaller than kₘₐₓ based on the statistical distributions of these samples. Using the initial clustering result as the initial condition and assuming a Gaussian distribution for each cluster, the Gaussian parameters may be estimated.

Some embodiments may use Lab color space. Lab is a 3D space with a property that L, a, b can be treated independently. Assuming Lab color space is used, some embodiments may assume that the L, a, and b channels are independent by using a diagonal covariance matrix; thus there are six parameters for each Gaussian, and a mean value and variance value for each channel. In some embodiments, an Expectation Maximization (EM) procedure may be used to create a mixture of Gaussians; each pixel can belong to multiple Gaussians with soft membership values. Other embodiments may use other techniques than EM to create a mixture of Gaussians.

Other embodiments may use other color spaces, for example RGB. It is not necessarily true that channels may be treated independently in other color spaces. However, Gaussian distribution may still be determined using other color spaces than Lab color space, even if the channels are not independent, by using different methods.

In some embodiments, kₘₐₓ may be set to 5. Other embodiments may use other values for kₘₐₓ.

In some embodiments, two GMMs may be estimated for each region: a positive GMM G_{F} and a negative GMM G_{B}. The positive model may be trained by using all the positive color samples—e.g., all pixels marked as in a region by the user with a specific scribble or scribbles for the corresponding class. All other pixels marked by the user with other scribbles may be used as negative samples to train the negative model, since these pixels belong to all other classes but the current class. Given a new pixel Iᵢ, the pixel's classification score may be computed as the difference of two log probability:

p_{I}(Iᵢ)=log(G_{F}(Iᵢ))−log(G_{B}(Iᵢ))

p_{I}(Iᵢ) can be either positive or negative; a large positive p_{I}(Iᵢ) indicates a higher probability of being foreground for this specific class, while a negative value for p_{I}(Iᵢ) indicates a higher probability of being background for this specific class.

In some embodiments, to conservatively apply the color models and avoid misclassifications, for each class, a threshold T may be computed as:

T=max(log(G_{F}(Bᵢ)))

where Bᵢ are all negative samples in the training set. Thus, threshold T may be based on applying the positive color model to the negative training samples. The threshold T may be set at or above the point where any pixels in the negative samples would be misclassified.

For a given pixel Iᵢ, the final foreground probability P_{F}(Iᵢ) may be computed as:

$${P}_{F} ( {I}_{i} ) = \{ \begin{matrix}1 , & {p}_{l} ( {I}_{i} ) \geq T \\ {( \frac{{p}_{l} ( {I}_{i} )}{T} )}^{x} , & 0 < {p}_{l} ( {I}_{i} ) < T \\ 0 , & {p}_{l} ( {I}_{i} ) \leq 0\end{matrix}$$

In other words, given threshold T, if the probability for a given pixel Iᵢ is at or above T, the pixel is in the region, and the final probability P_{F} for the pixel Iᵢ is set to 1. If the probability for the given pixel Iᵢ is less than or equal to 0, the pixel is not in the region, and the final probability P_{F} for the pixel Iᵢ is set to 0. If the probability for the given pixel Iᵢ is between 0 and T, an intermediate probability:

$${( \frac{{p}_{l} ( {I}_{i} )}{T} )}^{x}$$

is assigned to the pixel. The division by T is to normalize the probability between 0 and 1. The value is raised to the power x. The higher the value for x, the faster the computed probability degrades or drops below T. In some embodiments, x=3. In some embodiments, x may be adjustable.

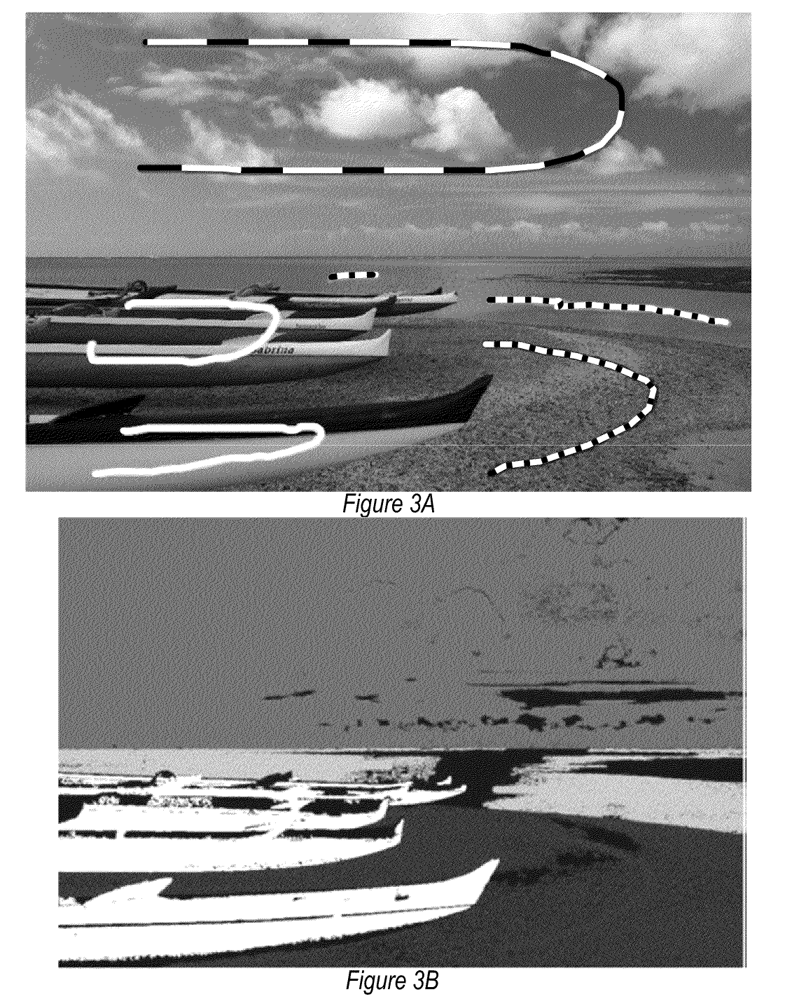

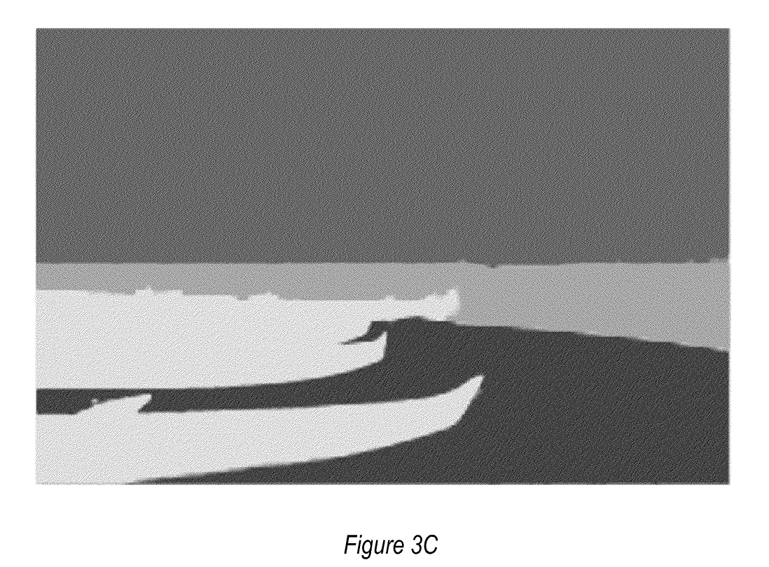

FIGS. 3A and 3B show an example of an initial probability map computed according to some embodiments. FIG. 3A shows an input image with several strokes or scribbles in different regions of the input image. The different types of lines (i.e., the solid white lines and the different black-and-white dashed lines) used in the strokes indicate that the user has marked different target regions of the image (in this example, four different regions). Note that, in color imaging, different colors may be used to indicate different regions. Other methods for indicating different regions may be used in various embodiments. FIG. 3B shows an example initial probability map computed from the input image and user input of FIG. 3A. Note that FIG. 3B is an example of an output of element 110 of FIG. 1, before post-processing and geodesic smoothing 112 are applied. Black pixels indicate pixels that have almost zero probability of being any one of the target regions, according to the conservative color models. These pixels may be assigned with proper probability values during geodesic smoothing as described below. FIG. 3C shows an example of a final region selection mask produced by applying geodesic smoothing, as described below, to the map of FIG. 3B. The different shades indicate the classification of pixels into the four different regions according to the user's specifications provided by the strokes shown in FIG. 3A.

### Post-Processing

As indicated at 204 of FIG. 2, post-processing may be optionally performed to remove outliers. The following describes post-processing operation(s) that may be performed on an initial probability map, such as the example shown in FIG. 3B, in some embodiments. The post-processing operation(s) may be performed for each class. In some embodiments, an initial probability map may be post-processed to remove structural outliers for each user-specified region or class. Outliers may include transitional pixels that are not connected to known in-class pixels. In some embodiments, probability value thresholds may be applied; for example, probability values of more than 95% may be assumed to be in the corresponding class (in-class pixels), probability values less than 5% may be assumed to be not in the class, and probability values between 5% and 95% are assumed as transitional pixels. Other embodiments may use different probability value thresholds. In some embodiments, the probability value thresholds may be user-adjustable. The probability value thresholds may be applied to create an N-layer map (e.g., a 3-layer map). A flood fill may be computed from the in-class pixels to the transitional pixels to identify those transitional pixels that are, in fact, connected. In some embodiments, any pixels that were classified as transitional but that are determined to not be connected to in-class pixels are determined to not be true transitional pixels; these pixels are removed from the class. In one embodiment, to remove pixels from a class, values of these pixels corresponding to the class may be set to zero.

In some embodiments, structural outliers may also include small areas (e.g., an area whose size is below a size threshold) of in-class pixels that are not connected to known in-class pixel areas, e.g. an area where a user has provided a stroke that is used to identify the class. In some embodiments, areas of in-class pixels may be identified, sizes of these areas may be computed, and one or more outliers (areas whose sizes are below a size threshold and that are not connected to other areas) may be removed from the class (e.g. by setting the pixel values to zero). In some embodiments, the size threshold may be adjustable. In some embodiments, removal of these small isolated areas of in-class pixels may be optional. For example, a user interface may provide a user interface element whereby a user my selectively choose to remove these areas or to leave these areas. In some embodiments, this user interface may also provide a user interface element whereby the user may specify the size threshold to be used in filtering the areas of in-class pixels to remove outliers. In some embodiments, these user interface options for removing (or leaving) small isolated areas of in-class pixels may be provided separately for each class.

### Geodesic Smoothing

As indicated at 206 of FIG. 2, geodesic smoothing may be applied to the initial probability map to generate a final region selection mask. Geodesic smoothing may be applied to initial probability maps (after post-processing as described above, if performed) to make soft transitions, and also to propagate probability values from classified pixels to unclassified ones (e.g., the black pixels in FIG. 3B). In some embodiments this operation is applied to each class individually. In some embodiments, this operation may be performed in parallel on two or more classes. The following discussion addresses how this operation is applied to a single class according to some embodiments.

Given any two pixels a and b, the geodesic distance between the pixels may be defined as:

$$d ( a , b ) = {min}_{Γ ∈ {R}_{a , b}} {\int }_{0}^{1} \sqrt{{‖ {Γ}^{′} ( s ) ‖}^{2} + {{ϒ}^{2} ( ∇ I \cdot u )}^{2}} d s \qquad ( 1 )$$

where R_{a,b} represents all possible paths on the image lattice between pixel a and b, with Γ(s) indicating one such path. The geodesic distance is essentially an integration operation over the path; the first term ∥Γ′(s)∥² is the spatial distance over the path, and the second term (∇I·u)² is the sum of the color difference between pixels over the path. γ is a weighting controlling the influence of the color difference. If γ is zero, then d(a,b) degrades to the line distance between a and b.

Suppose there is one pixel I₀ in an image that has a foreground probability of 1, and all other pixels have a probability of 0. Then the probability map is essentially a one-pixel pulse function. To perform geodesic smoothing on this probability map, for every other pixel a geodesic distance to I₀ may be computed as d(Iᵢ, I₀), and the distance can be transferred into a probability as:

P(Iᵢ)=max(0,1−φ·d(Iᵢ,I₀)).

In this way, the function may be smoothed into a Gaussian-like function centered at I₀, where the probability gradually decease when moving further away from the center, and may present a sharp drop when crossing a strong color edge.

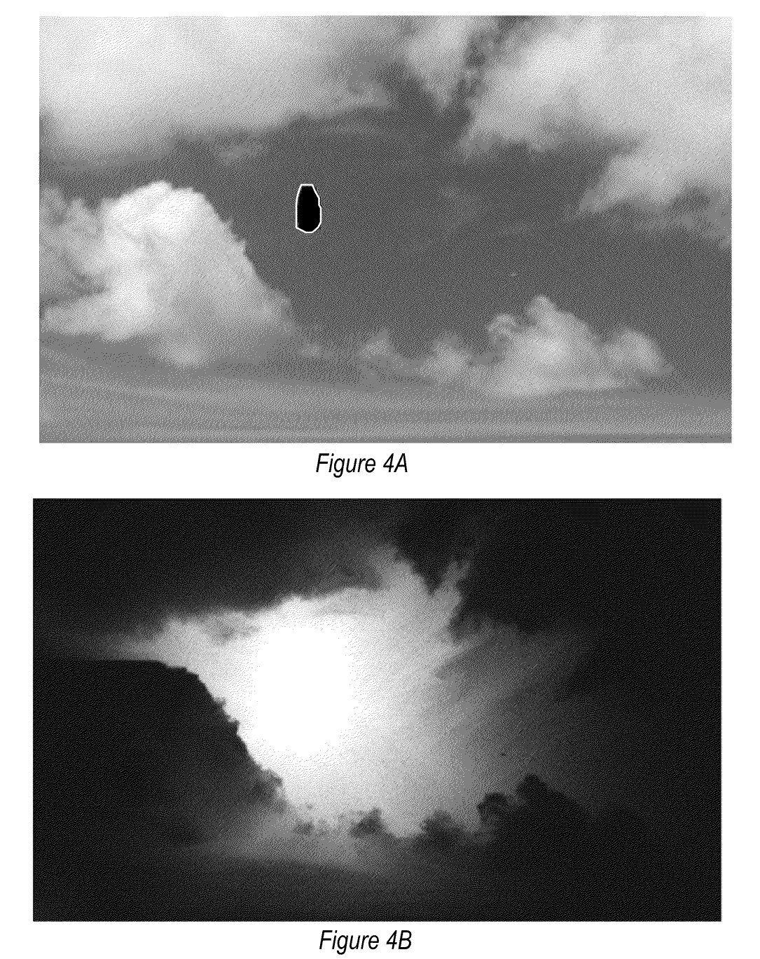

FIGS. 4A and 4B show an example of computing geodesic distances and of geodesic smoothing according to some embodiments. In FIG. 4A, pixels under the black area with a white border are source pixels which have a probability of 1 (or initial distance of 0). FIG. 4B shows the final probability map (inverse to the geodesic distance) computed from FIG. 4A, and illustrates how geodesic smoothing respects the strong edge presented in the image.

### An Alternative Geodesic Distance Calculation

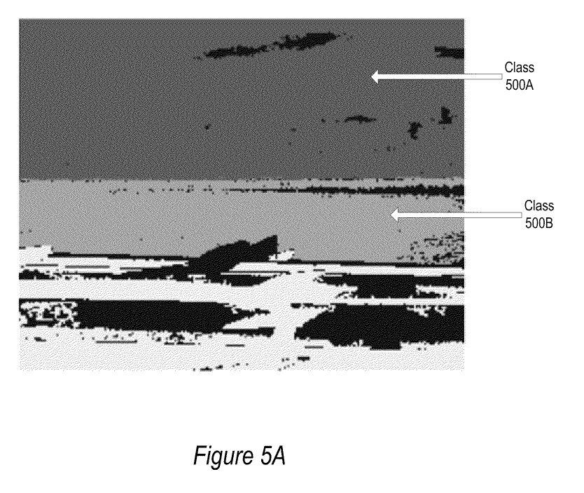

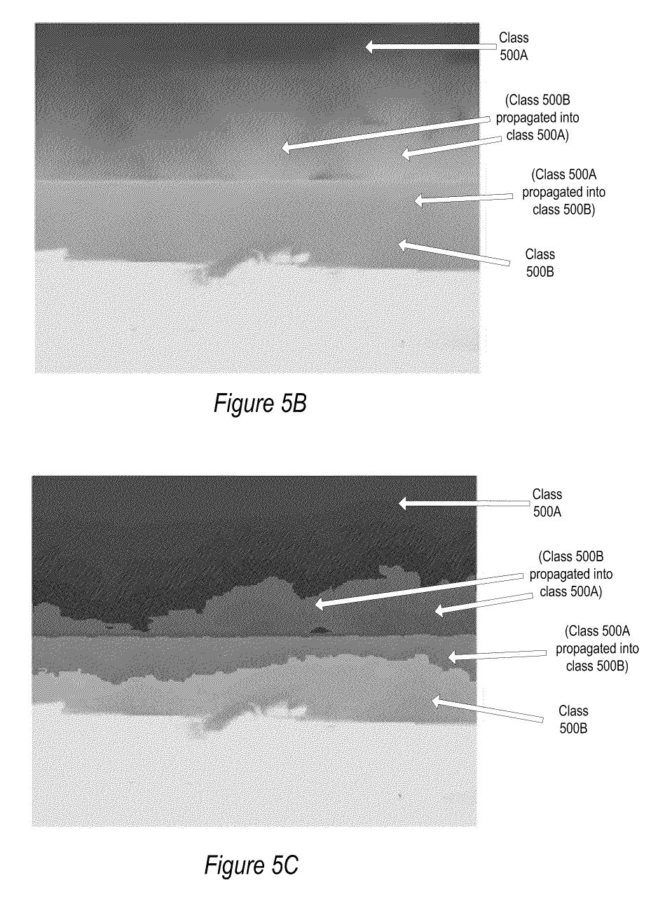

As indicated at 206 of FIG. 2, geodesic smoothing may be applied to the initial probability map to generate a final region selection mask. This section describes an alternative geodesic smoothing technique that may be used in some embodiments. The geodesic smoothing technique described in the previous section may work well for single layer smoothing. However, this technique lacks the ability to allow different regions to compete with each other; thus, after smoothing, one region may spread inside another region. An example is shown in FIGS. 5A through 5C. FIG. 5A shows an initial mask generated using color models according to some embodiments, and shows a class or region 500A and a class or region 500B (the regions are shown as different levels of grayscale in this example). FIG. 5B shows the mask of FIG. 5A after geodesic smoothing as described in the previous section using equation (1). Note that classes 500A and 500B have been propagated into each other's regions. FIG. 5C shows a posterized version of FIG. 5B in which this propagation of classes into other regions is more visible.

To address this problem, some embodiments may add an extra term into the geodesic distance computation of equation (1) to produce equation (2) as shown below. For every pixel Iᵢ the method computes the pixel's maximum probability among all classes as Pₘⁱ, and applies Pₘⁱ as a third term in the definition of geodesic distance as follows:

$$d ( a , b ) = {min}_{Γ ∈ {R}_{a , b}} {\int }_{0}^{1} \sqrt{{‖ {Γ}^{′} ( s ) ‖}^{2} + {{ϒ}^{2} ( ∇ I \cdot u )}^{2} + β \cdot {P}_{m}^{s}} d s \qquad ( 2 )$$

A larger Pₘⁱ may indicate that the current pixel has already been confidently assigned to a class/region; thus, any integration across this pixel may result in a large distance. Therefore, this pixel may work as a strong edge to limit or prevent propagation across the pixel. In this way, some embodiments, by using equation (2), may insure that the propagation stops properly and avoids the problem of propagation across regions that may occur using the previously described geodesic smoothing method that uses equation (1) for geodesic distances.

In equation (2), β is a weight for Pₘ^{m}, that may, in some embodiments, be used to control the application of parameter Pₘⁱ. If β set to 0, the geodesic smoothing is performed according to equation (1). A non-zero value for β may thus be used to control the amount of propagation across edges between regions, with a higher value being more restrictive. Note that some embodiments may not include the weight β.

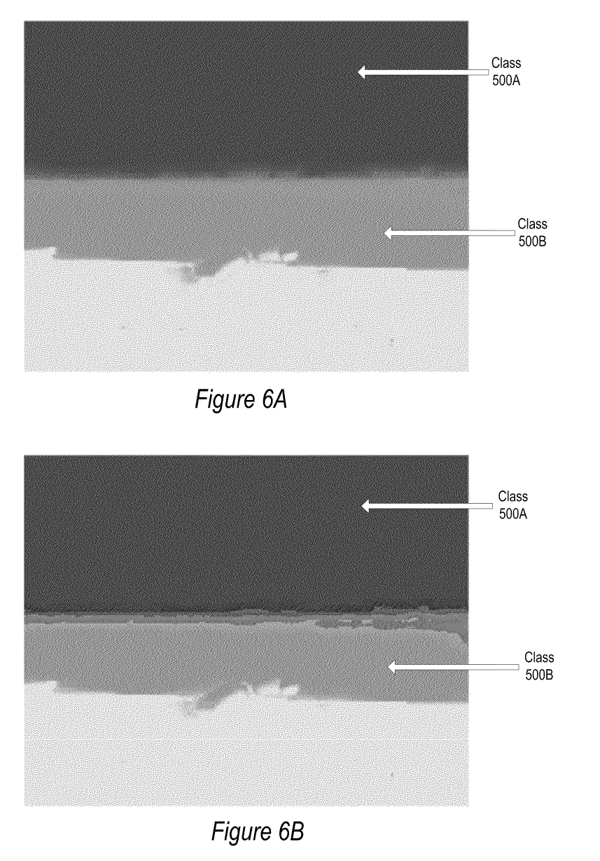

FIGS. 6A and 6B show the mask of FIG. 5A after geodesic smoothing using equation (2), according to some embodiments. Note that propagation stops at the boundary of classes 500A and 500B. FIG. 6B shows a posterized version of FIG. 6A in which the regions are more visible.

### Implementations

To apply geodesic smoothing to the probability map computed according to GMM, some embodiments may perform the following. The initial probability map may be transferred to a distance map, as follows. Note that v is a constant:

d(Iᵢ)=v(1−P(Iᵢ))

A geodesic distance transform may be performed. For every pixel, the pixel's final distance may be computed as:

d(Iᵢ)=min(d(Iᵢ),d(Iᵢ,Iⱼ)_{—}+d(Iⱼ))

where j represents all pixels in the image except i.

The final probability may be computed as:

$$P ( {I}_{i} ) = exp ( - \frac{{d ( {I}_{i} )}^{2}}{{θ}^{2}} )$$

where θ is a smoothness parameter, which in some embodiments may be specified or changed by the user. Decreasing the value of θ may result in sharper region boundaries, while increasing the value of θ may result in smoother transitions between regions.

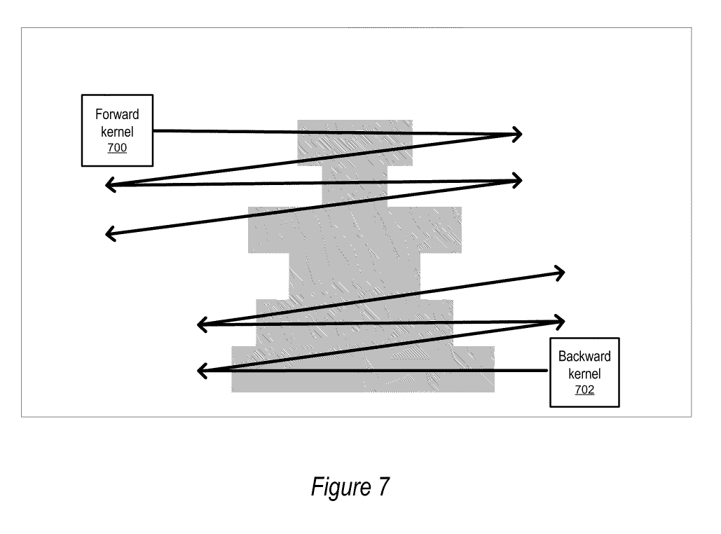

Computing the pixel's final distance may be a key step in geodesic smoothing. In some embodiments, this may be achieved using a raster-scan algorithm. Basically the algorithm scans the image twice, the first time from the top-left corner to the bottom-right corner (referred to as the forward pass), and the second time in the reverse direction (referred to as the backward pass). Different kernels may be used for each pass. This method is illustrated in FIG. 7, which graphically illustrates a forward pass over a region using a forward kernel 700 and a backward pass over the same region using a backward kernel 702, according to some embodiments. In some embodiments, the smallest neighborhood (3*3) for geodesic distance approximation may be used as the kernel size. In other embodiments, a 5*5 kernel size may be used. Other sizes for kernels, or other methods for computing the pixel's final distance, may be used in various embodiments.

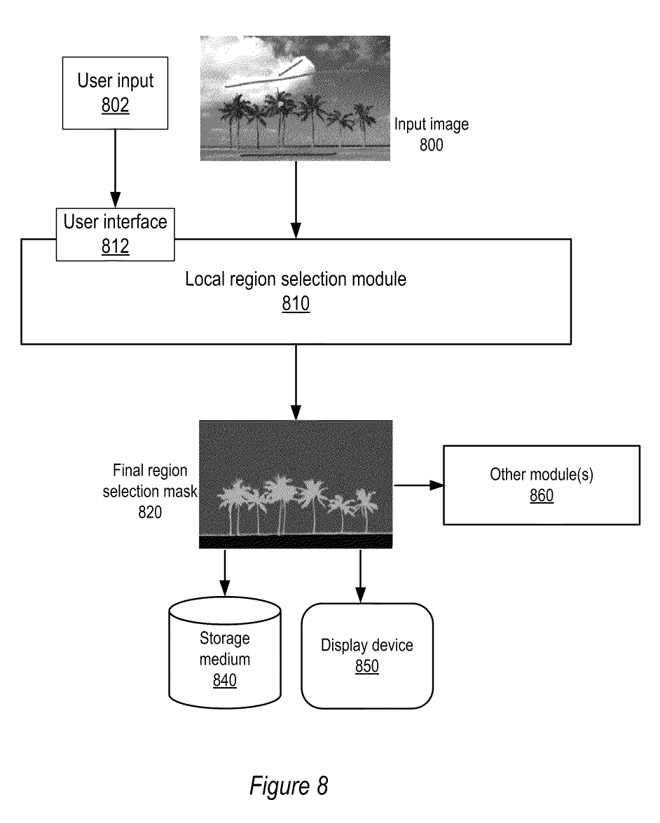

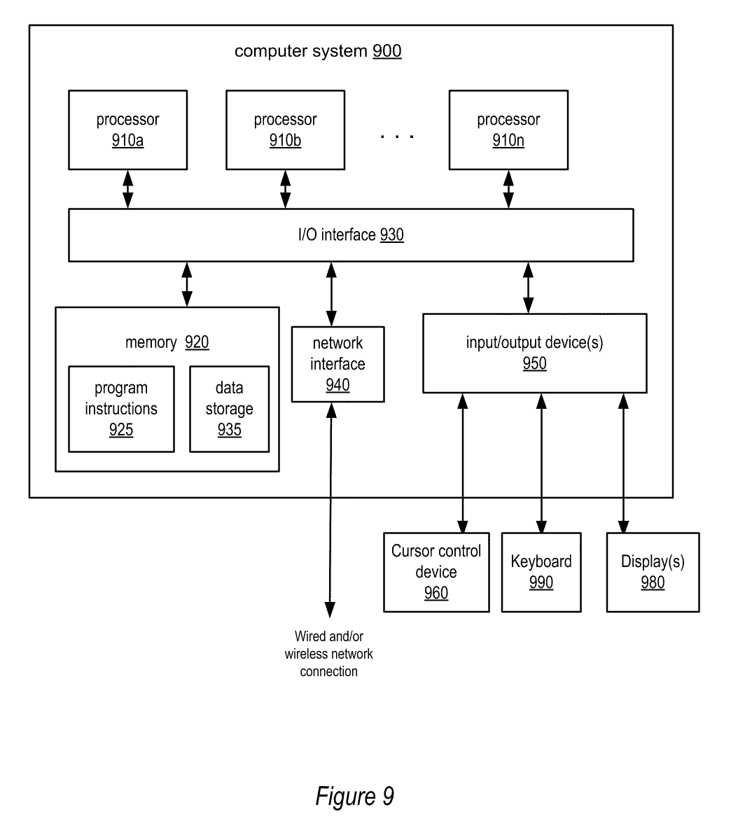

Some embodiments may include a means for building and applying color models and a means for geodesic smoothing as described herein. For example, a toolkit, application, or library may include a module for building and applying color models and a module for geodesic smoothing. Alternatively, some embodiments may provide a single module that performs both building and applying color models and geodesic smoothing; see, for example, local region selection module 810 of FIG. 8. The module(s) may in some embodiments be implemented by a computer-readable storage medium and one or more processors (e.g., CPUs) of a computing apparatus. An example computer system in which embodiments of the module(s) may be implemented is illustrated in FIG. 9. The computer-readable storage medium may store program instructions executable by the one or more processors to cause the computing apparatus to perform building and applying color models and a means for geodesic smoothing as described herein to generate a final region selection mask. Other embodiments of the module(s) may be at least partially implemented by hardware circuitry and/or firmware stored, for example, in a non-volatile memory. Embodiments of the module(s), may be implemented, for example, as stand-alone applications, modules in other applications, modules in libraries, modules in toolkits, and so on.

FIG. 8 illustrates a local region selection module that may generate final region selection masks from input images and user input, according to some embodiments. Local region selection module 810 may implement methods for building and applying color models and for geodesic smoothing as described above. These methods may be implemented as submodules of local region selection module 810 or may be implemented as separate modules, for example as modules in a library. FIG. 9 illustrates an example computer system on which embodiments of local region selection module 810 may be implemented. Referring to FIG. 8, local region selection module 810 receives an input image 800 and user input (e.g., scribbles specifying one or more regions). In some embodiments, local region selection module 810 may provide a user interface 812 via which a user may interact with the module 810, for example to specify regions, specify parameters to be used in the local region selection methods as described herein, and so on. Local region selection module 810 processes the input image 800 and user input according to the methods described herein, for example according to the method illustrated in FIG. 2. Local region selection module 810 generates as output a final region selection mask 820. Final region selection mask 820 may, for example, be stored to a storage medium 840, such as system memory, a disk drive, DVD, CD, etc. Instead, or in addition, final region selection mask 820 may be displayed to a display device 850, or provided to one or more other modules 860 for additional processing.

### Example System

Various components of embodiments of a local region selection method as described herein may be executed on one or more computer systems, which may interact with various other devices. One such computer system is illustrated by FIG. 9. In the illustrated embodiment, computer system 900 includes one or more processors 910 coupled to a system memory 920 via an input/output (I/O) interface 930. Computer system 900 further includes a network interface 940 coupled to I/O interface 930, and one or more input/output devices 950, such as cursor control device 960, keyboard 990, audio device 990, and display(s) 980. In some embodiments, it is contemplated that embodiments may be implemented using a single instance of computer system 900, while in other embodiments multiple such systems, or multiple nodes making up computer system 900, may be configured to host different portions or instances of embodiments. For example, in one embodiment some elements may be implemented via one or more nodes of computer system 900 that are distinct from those nodes implementing other elements.

In various embodiments, computer system 900 may be a uniprocessor system including one processor 910, or a multiprocessor system including several processors 910 (e.g., two, four, eight, or another suitable number). Processors 910 may be any suitable processor capable of executing instructions. For example, in various embodiments, processors 910 may be general-purpose or embedded processors implementing any of a variety of instruction set architectures (ISAs), such as the x86, PowerPC, SPARC, or MIPS ISAs, or any other suitable ISA. In multiprocessor systems, each of processors 910 may commonly, but not necessarily, implement the same ISA.

In some embodiments, at least one processor 910 may be a graphics processing unit. A graphics processing unit or GPU may be considered a dedicated graphics-rendering device for a personal computer, workstation, game console or other computer system. Modem GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods disclosed herein for local region selection may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 920 may be configured to store program instructions and/or data accessible by processor 910. In various embodiments, system memory 920 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for a local region selection method, are shown stored within system memory 920 as program instructions 925 and data storage 935, respectively. In other embodiments, program instructions and/or data may be received, sent or stored upon different types of computer-accessible media or on similar media separate from system memory 920 or computer system 900. Generally speaking, a computer-accessible medium may include storage media or memory media such as magnetic or optical media, e.g., disk or CD/DVD-ROM coupled to computer system 900 via I/O interface 930. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 940.

In one embodiment, I/O interface 930 may be configured to coordinate I/O traffic between processor 910, system memory 920, and any peripheral devices in the device, including network interface 940 or other peripheral interfaces, such as input/output devices 950. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. In addition, in some embodiments some or all of the functionality of I/O interface 930, such as an interface to system memory 920, may be incorporated directly into processor 910.

Network interface 940 may be configured to allow data to be exchanged between computer system 900 and other devices attached to a network, such as other computer systems, or between nodes of computer system 900. In various embodiments, network interface 940 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 950 may, in some embodiments, include one or more display terminals, keyboards, keypads, touchpads, scanning devices, voice or optical recognition devices, or any other devices suitable for entering or retrieving data by one or more computer system 900. Multiple input/output devices 950 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

As shown in FIG. 9, memory 920 may include program instructions 925, configured to implement embodiments of a local region selection method as described herein, and data storage 935, comprising various data accessible by program instructions 925. In one embodiment, program instructions 925 may include software elements of a local region selection method illustrated in the above Figures. Data storage 935 may include data that may be used in embodiments, for example input PDF documents or output layout-preserved text documents. In other embodiments, other or different software elements and/or data may be included.

Those skilled in the art will appreciate that computer system 900 is merely illustrative and is not intended to limit the scope of a local region selection method as described herein. In particular, the computer system and devices may include any combination of hardware or software that can perform the indicated functions, including computers, network devices, internet appliances, PDAs, wireless phones, pagers, etc. Computer system 900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A computer-implemented method, comprising:
obtaining an image and specifications of multiple classes of content of the image, the specifications of the multiple classes made via selection of one or more pixels in the images;
training a Gaussian mixture model (GMM) for each specified class of content of the image based on the specification made via the selection of the one or more pixels in the image, each said GMM capturing color statistics of pixels in the image indicated by the specifications as belonging to the respective said class of content of the image; and
applying each of the GMMs to the image to generate a probability map for each said class, probability map for a respective said class indicating, for each of the pixels in the image, a probability that the pixel is in the respective class.

2. The computer-implemented method as recited in claim 1, wherein each said specification is a user input indicating a set of the one or more pixels in the image as corresponding to a respective said class of content.

3. The computer-implemented method as recited in claim 2, wherein the user input is a stroke or scribble drawn over the image.

4. The computer-implemented method as recited in claim 1, further comprising smoothing each of the probability maps for the classes according to a geodesic smoothing technique to generate smoothed probability maps for the classes.

5. The computer-implemented method as recited in claim 4, wherein:
the geodesic smoothing technique considers other classes when smoothing the probability map for a particular class to limit or prevent propagation of the particular class into regions corresponding to the other classes;
wherein said smoothing smoothes transitions between regions corresponding to different said classes in the probability maps and classifies previously unclassified pixels into the classes; or
further comprising combining the smoothed probability maps to generate a final region selection mask for the image, wherein the final region selection mask indicates a separate region corresponding to each said class.

6. The computer-implemented method as recited in claim 44, further comprising removing structural outliers from the probability maps prior to said smoothing.

7. A system, comprising:
at least one processor; and
a memory comprising program instructions, wherein the program instructions are executable by the at least one processor to:
obtain an image and specifications of multiple classes of content of the image, the specifications of the multiple classes made via selection of one or more pixels in the image;
train a Gaussian mixture model (GMM) for each said specified class of content of the image, each said GMM capturing color statistics of pixels in the image indicated by the specifications as belonging to the class of content of the image;
apply each of the GMMs to the image to generate a probability map for each said that indicates, for each said pixel in the image, a probability that the pixel is in the respective said class;
apply a smoothing technique to smooth each of the probability maps for the classes to generate smoothed probability maps for the classes; and
combine the smoothed probability maps to generate a final region selection mask for the image, the final region selection mask indicating a separate region corresponding to each class.

8. The system as recited in claim 7, wherein each said specification is a user input indicating a set of the one or more pixels in the image as corresponding to a respective said class of content.

9. The system as recited in claim 8, wherein the system further includes a user input device and a display device, and wherein each user input is a stroke or scribble drawn, via the user input device, over the image displayed on the display device.

10. The system as recited in claim 7, wherein, in said smoothing technique, the program instructions are executable by the at least one processor to smooth transitions between regions corresponding to different said classes in the probability maps and to classify previously unclassified pixels into the classes.

11. The system as recited in claim 7, wherein, in said smoothing technique, the program instructions are executable by the at least one processor to consider other said classes when smoothing the probability map for a particular said class to limit or prevent propagation of the particular said class into regions corresponding to the other said classes.

12. The system as recited in claim 7, wherein the program instructions are executable by the at least one processor to remove structural outliers from the probability maps prior to said smoothing.

13. A tangible computer-readable storage medium storing program instructions, wherein the program instructions are computer-executable to implement:
training a Gaussian mixture model (GMM) for specified plurality of class of content of the image, each said GMM capturing color statistics of pixels in the image indicated by specifications made via selection of one or more pixels in the image as belonging to the respective class of content of the image;
applying each of the GMMs to the image to generate a probability map for each said class that indicates, for each said pixel in the image, a probability that the pixel is in a respective said class; and
smoothing each of the probability maps for the classes to generate smoothed probability maps for the classes.

14. The tangible computer-readable storage medium as recited in claim 13, wherein each said specification is a user input indicating a set of the one or more pixels in the image as corresponding to a respective said class of content.

15. The tangible computer-readable storage medium as recited in claim 13, further comprising combining the smoothed probability maps to generate a final region selection mask for the image that indicates a separate region corresponding to each said class.

16. The tangible computer-readable storage medium as recited in claim 13, wherein said smoothing smoothes transitions between regions corresponding to different said classes in the probability maps and classifies previously unclassified pixels into the classes.

17. The tangible computer-readable storage medium as recited in claim 13, wherein the smoothing technique is a geodesic smoothing technique considers other classes when smoothing the probability map for a particular class to limit or prevent propagation of the particular class into regions corresponding to the other classes.

18. The tangible computer-readable storage medium as recited in claim 13, wherein the program instructions are computer-executable to implement removing structural outliers from the probability maps prior to said smoothing.

19. The tangible computer-readable storage medium as recited in claim 13, wherein said training of the Gaussian mixture model (GMM) for each said class comprises training a positive GMM and a negative GMM for each said class, the positive GMM is trained from pixels indicated by the specifications as belonging to this class, and where the negative GMM is trained from said pixels indicated by the specifications as not belonging to this class.

20. The tangible computer-readable storage medium as recited in claim 19, wherein said applying the GMMs to the image to generate a probability map for each class comprises, for each class:
determining a threshold T for this class, where T is at or above a value where pixels indicated by the specifications as not belonging to this class would be misclassified as belonging to this class;
for each pixel in the image:
calculating an initial classification score Pᵢ(Iᵢ) for the pixel from the positive GMM and the negative GMM for this class; and
calculating a final foreground probability PF(h) for the pixel according to:
$${P}_{F} ( {I}_{i} ) = \{ \begin{matrix}1 , & {p}_{l} ( {I}_{i} ) \geq T \\ {( \frac{{p}_{l} ( {I}_{i} )}{T} )}^{x} , & 0 < {p}_{l} ( {I}_{i} ) < T \\ 0 , & {p}_{l} ( {I}_{i} ) \leq 0.\end{matrix}$$
